(19) United States
(12) Patent Application Publication
(10) Pub. No.: US 2015/0235323 A1
(43) Pub. Date: Aug. 20, 2015

(54) AUTOMATED VEHICLE CRASH DETECTION

(71) Applicant: Himex Limited, London (GB)

(72) Inventor: Russ L. OLDHAM, Scottsdale, AZ (US)

(21) Appl. No.: 14/626,538

(22) Filed: Feb. 19, 2015

Related U.S. Application Data
(63) Continuation-in-part of application No. 14/532,084, filed on Nov. 4, 2014.
(60) Provisional application No. 61/941,651, filed on Feb. 19, 2014.

(51) Int. Cl. G06Q 40/08; G07C 5/00

(52) U.S. Cl. CPC G06Q 40/08; G07C 5/008

(57) ABSTRACT

An automated crash detection device comprises a housing mountable in a vehicle. An acoustic sensor is operatively coupled to the housing to sense vehicle structure born sound waves and develop an acoustic reading representative thereof. An accelerometer is operatively coupled to the housing to sense G-force and develop an accelerometer reading representative thereof. A processing system is operatively associated with the acoustic sensor and the accelerometer to detect a crash condition responsive to the acoustic reading and the accelerometer reading. A transmitter is operatively associated with the processing system to transmit a crash notification upon detection of a crash condition.

### CROSS-REFERENCE TO RELATED APPLICATIONS

This application claims priority of provisional application No. 61/941,651, filed Feb. 19, 2014, and is a continuation-in-part of application Ser. No. 14/532,084, filed Nov. 14, 2014.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This application relates to insurance claim processing and, more particularly, to detecting abnormal vehicular movement events.

### BACKGROUND

Late reporting of losses has plagued personal and commercial line automobile insurance carriers for years. Delayed loss reporting often leads to increased cost both for physical damage and bodily injury. There also may be prolonged liability investigations due to a cold evidence trail and heightened consumer dissatisfaction.

Many insurance carriers have attempted to compress life cycle by encouraging prompt reporting of losses. One known solution offered policy holders a reduced physical damage deductible for prompt reported losses. Another known carrier scaled producer compensation based on the loss reporting behavior of their insureds. However, neither resulted in a significant change in loss reporting timeliness. Thus, the insurers' attempts to compress the claim life cycle had failed to produce the desired results due to the reliance upon policy holders and claimants to timely report losses.

The present application is directed to improvements in detection and notification of abnormal vehicular movement events to thereby improve loss reporting and claims adjustment processes.

### SUMMARY

As described herein, an improved system allows a connected vehicle to electronically transmit notice of loss to a first party insurance provider within seconds of an abnormal vehicular movement event. Events are pre-determined behavioral triggers that are detected through a device connected to a vehicle or a cellular device. The device measures vehicle movement along with acoustic readings that may indicate that a vehicular crash has occurred.

There is disclosed in accordance with one aspect a device for detecting abnormal vehicular movement events comprising a support member mountable in a vehicle. An acoustic sensor is operatively coupled to the support member to sense vehicle structure born sound waves and develop an acoustic reading representative thereof. An accelerometer is operatively coupled to the support member to sense G-force and develop an accelerometer reading representative thereof. A processing circuit is operatively associated with the acoustic sensor and the accelerometer to detect a crash condition responsive to the acoustic reading and the accelerometer reading.

It is a feature that the processing circuit may detect a crash condition responsive to both the acoustic reading and the accelerometer reading each being above a select threshold.

It is another feature to provide a transmitter operatively associated with the processing circuit to transmit a crash notification upon detection of a crash condition. The processing circuit may store a previous accelerometer reading as pre-crash data upon a detection of a crash condition.

It is another feature that the processing circuit may comprise a global positioning system to track vehicle location. The processing circuit may transmit vehicle location with the crash notification upon detection of a crash condition.

It is another feature to provide an interface coupled to a vehicle onboard diagnostic (OBD) device and the processing circuit stores OBD data. A transmitter may transmit a crash notification upon detection of a crash condition with the crash notification comprising OBD data. The processing circuit may sample OBD data and accelerometer readings in a non-burst mode in the absence of a crash condition and upon detection of a crash condition data sample rate may switch to a burst mode. Duration of burst mode data collection and transmission may continue for a select period subsequent to detection of a crash condition.

There is disclosed in accordance with another aspect an automated crash detection device comprising a housing mountable in a vehicle. An acoustic sensor is operatively coupled to the housing to sense vehicle structure born sound waves and develop an acoustic reading representative thereof. An accelerometer is operatively coupled to the housing to sense G-force and develop an accelerometer reading representative thereof. A processing system is operatively associated with the acoustic sensor and the accelerometer to detect a crash condition responsive to the acoustic reading and the accelerometer reading. A transmitter is operatively associated with the processing system to transmit a crash notification upon detection of a crash condition.

Further features and advantages will be readily apparent from the specification and from the drawings.

### BRIEF DESCRIPTION OF THE DRAWINGS

FIG. 1 is a diagrammatic representation of features of an electronic first notice of loss process utilizing an automated crash detection device as disclosed herein;

FIG. 2 is a block diagram of a system for notification of abnormal vehicular movement events using the automated crash detection device described herein;

FIG. 3 is a generalized diagram illustrating data transferred from vehicle monitoring devices associated with abnormal vehicular movement events;

FIG. 4 is a block diagram of the automated crash detection device illustrated in FIG. 2;

FIG. 5 is a flow diagram illustrating operation of a program in the processor of FIG. 4 to detect a crash condition; and

FIG. 6 is a detailed flow diagram illustrating an event routine and a validation routine.

### DETAILED DESCRIPTION

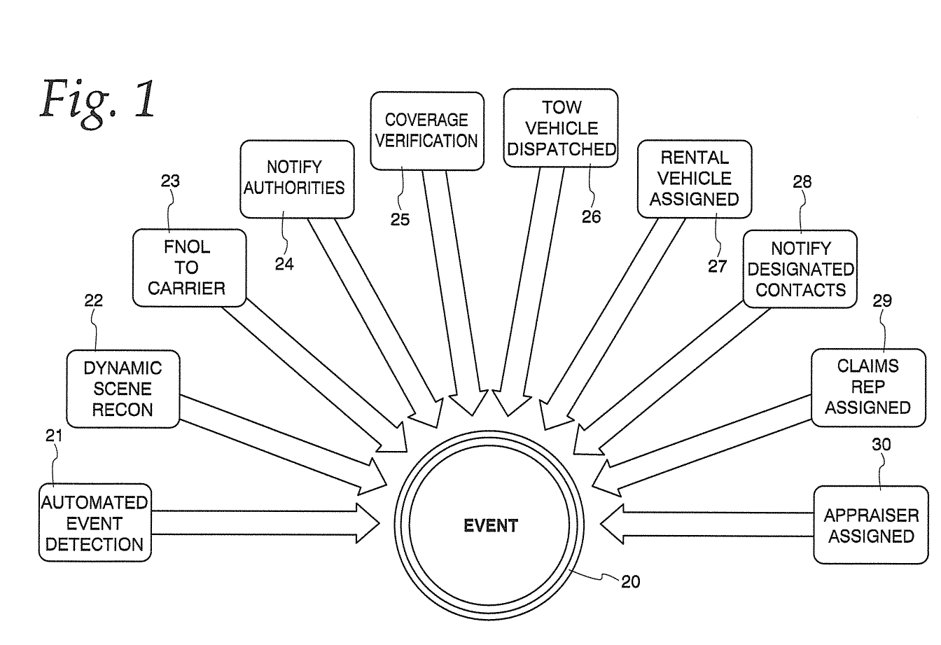

The system and methodology described herein comprises an intelligent claims environment (ICE) that automates the traditional first notice of loss (FNOL) process through electronically notifying insurance carriers, fleet managers, or any other client of an event within seconds after an event. FIG. 1 illustrates notifications and other features of the ICE subsequent to an event represented by a node 20. The event comprises an abnormal vehicular movement occurrence, as described more particularly below. This application is particularly directed to a device for detecting abnormal vehicular movement events used with the ICE.

An automated event detection block 21 initiates the FNOL. Events are pre-determined behavioural triggers that are detected through a monitoring device associated with a vehicle. The monitoring device may be a conventional onboard diagnostic (OBD) device, a hard wired black box, embedded OEM telematics devices, or the like. The monitoring device may also be a mobile device present in a vehicle. The monitoring device(s) measure driving and vehicle movement characteristics which may indicate that a loss has occurred. Loss detection measurements and thresholds may include, for example, sudden acceleration, sudden deceleration, abnormal G-force readings, abnormal acoustic readings, crash sensor activation, roll over sensor activation, electronic control unit readings, air bag deployment, or the like.

Dynamic scene reconstruction is illustrated by a block 22. The ICE system stores driving and vehicle movement data up to a pre-set number of seconds before and after an event. This allows the ICE system to produce an animated recreation of the vehicle's movement and behaviour in a setting that mirrors that of the event. Each simulated video will track the location of the vehicle up to the point of impact and pinpoint its location based on latitude and longitude.

An FNOL to carrier block 23 allows a client to be notified of an event within seconds of occurrence through an ICE automated notification process. Notification can be via internet, text message, email message, social media, telephone call or any other communication method. Authorities are notified at a block 24. The ICE system may integrate with third party database providers of police, sheriff, fire departments, EMT/Ambulance companies, etc. An event triggers an automated email, electronic text or telephone message to the proper jurisdictional authority or client or other third party with notification of the event location, vehicle description and policy holder's name.

With a coverage verification block 25, the ICE system may integrate with a client's policy administration system to verify high level coverage requirements, such as policy period, location of event and vehicle. A tow vehicle dispatched block 26 works with a database that houses detailed profiles of previously sanctioned vehicle recovery vendors. The profile information includes geographic coverage area, location, hours of operation, vehicle recovery capacity, including gross vehicle weight (GVW), and pricing. A reverse auction process may weigh these factors to determine a lowest cost option along with most timely response. Once the ICE system's algorithm selects the vendor, an electronic message is sent to both the vehicle owner and the vendor with key dispatch information, including location and vehicle information. The vehicle owner's message will include name and telephone number of the vehicle recovery vendor that has been dispatched. Dispatch occurs within seconds of the event notification.

A rental vehicle assigned block 27 is used with a database and houses detailed profiles of automobile rental vendors who have been previously sanctioned by the client. This operates similar to the tow vehicle dispatched block 26, discussed above.

The ICE system can integrate with a carrier's policy administration system to locate the name, email address and telephone numbers of a vehicle owner's designated contacts. This is used at a notify designated contacts block 28. Once an event is triggered, the ICE system immediately generates an email, text or automated voice message notifying the designee that an event has occurred. Clients can also feed contact information to an ICE database, thus eliminating the need for full integration. The ICE system can be integrated with a client's claims administration system to assign a claim rep at a block 29. Finally, the ICE system can integrate with a client's claim or policy administration system to assign an appraiser at a block 30.

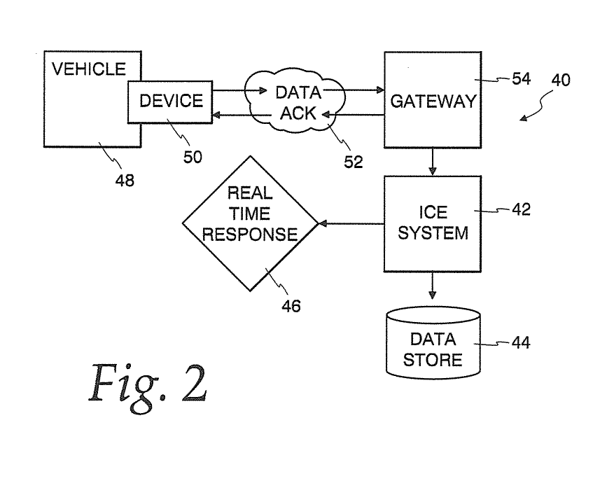

FIG. 2 comprises a block diagram showing an exemplary notification and management system 40. An ICE system 42 comprises a programmed computing system that combines hardware and software and related user interfaces for implementing the intelligent claims environment (ICE) described herein. The ICE system 42 may include one or more processors, personal computers, servers or the like, as necessary or desired. The ICE system 42 utilizes a data store device 44 which may comprise a database and other types of memory devices for storing data and programs used by the ICE system 42. The ICE system 42 may communicate with a carrier's real time response system 46 which may comprise a carrier's computer system and other devices to implement the features discussed above relative to FIG. 1.

The ICE system 42 is used to communicate with a plurality of insured vehicles, one of which is illustrated at 48. Each vehicle 48 includes a monitoring device 50 adapted for automated crash detection, as described herein. The monitoring device 50 may comprise a dongle device, onboard diagnostic (OBD) device, global positioning system (GPS) device, mobile device, such as a smart phone or tablet, or other telematic device, configured as described herein. Also, there may be more than one monitoring device used. The monitoring device 50 communicates wirelessly via a network 52 to a gateway 54. The gateway 54 comprises a communications server operatively connected to the ICE system 42. The gateway 54 accepts data messages from the device 50, decodes the message and routes it to the ICE system 42. The gateway 54 also provides an acknowledgment to the device 50. The ICE system 42 is operable to use received data associated with abnormal vehicular movement events from the gateway 54 and to determine if a collision has occurred and then take appropriate action as described below.

As described herein, the device 50 detects abnormal vehicular movement events. The device includes an acoustic sensor that senses vehicle structure borne sound waves and develops an acoustic reading. An accelerometer senses G-force and develops an accelerometer reading. The device detects a crash condition responsive to the acoustic reading and the accelerometer reading.

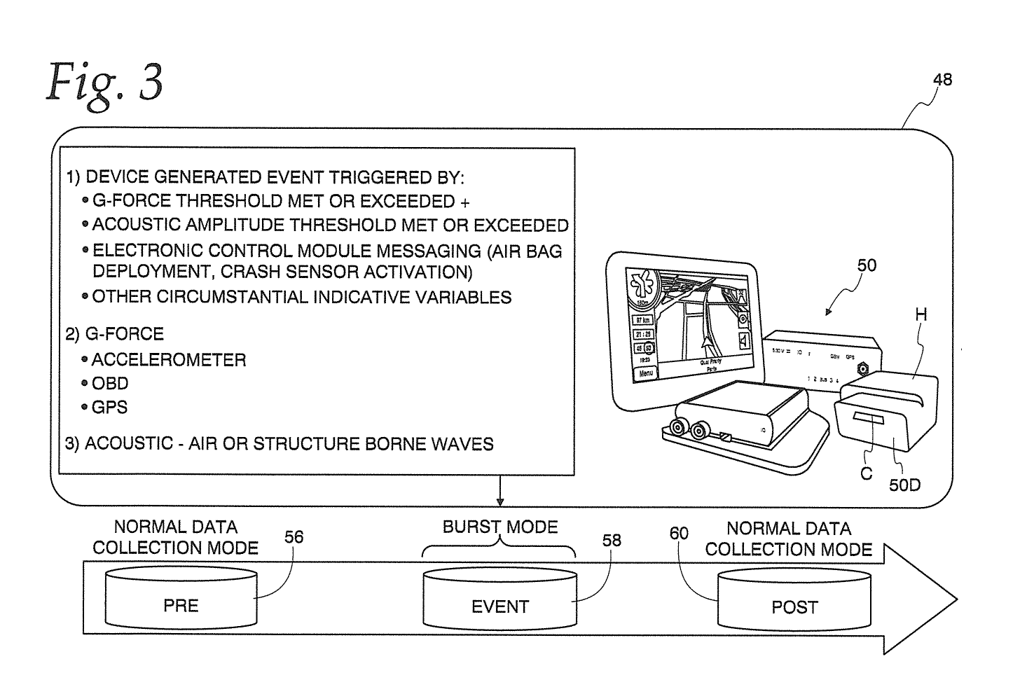

The implementation of the device in a hardware sense is dependent on technology that may already be available in a vehicle. In an exemplary configuration, as described herein, vehicles are equipped with onboard diagnostic (OBD) devices which provide diagnostic information available via an access port. For example, the OBD-II standard specifies a type of diagnostic connector and protocols and messaging formats along with a list of vehicle parameters to be monitored along with encoding requirements. Such a device is installed in a vehicle by the manufacturer. As such the OBD port is fixed in the vehicle and thus securely attached relative to the vehicle frame. In an illustrative embodiment, the device 50 may comprise a dongle 50D, see FIG. 3, which plugs into the vehicle OBD port. The dongle 50D includes a housing H and connector C for connection to the vehicle OBD port (not shown). As such, the dongle 50D is attached via the OBD port to the vehicle frame. Thus, the housing H is fixed in the vehicle and is responsive to vehicle movement and structure born sound waves.

Alternatively, the device 50 could take other known forms, such as a Smart Phone, dedicated GPS device, or other device including appropriate sensors and programming as specified herein. Any such device would be supported in the vehicle so that the device is responsive to vehicle movement and structure born sound waves. Indeed, such devices could be provided by a manufacturer in the vehicle, as will be apparent. This application is not directed to the particular hardware implementation of the device 50.

Referring to FIG. 3, various representative monitoring devices 50 are illustrated in a vehicle, represented by 48. These monitoring devices 50 are configured to generate an event trigger by one or more of several occurrences. These include, for example, a G-force threshold being met or exceeded, an acoustic amplitude threshold being met or exceeded, an electronic control module message, such as air bag deployment or crash sensor activation, or other circumstantial indicative variables. The G-force data may be determined from an accelerometer, an OBD device or GPS device. As will be appreciated, a device generated event can also be triggered by combinations of the various measured variables, such as both a G-force measurement and an acoustic measurement both being above a select threshold. The data measured by the monitoring device 50 is stored in a buffer which holds data for a select period of time, such as on the order of forty seconds. In a normal, non-burst, data collection mode, the buffer is continually updated with the oldest data being purged and replaced by newer data. If an event is triggered, then the monitoring device continues to collect data subsequent to the event as well as storing the buffered data from before the event. In an illustrated embodiment, the data may include data for approximately twenty seconds before the event in a pre-buffer 56, data at the time of the event at an event buffer 58 and data for approximately twenty seconds after the event at a post-buffer 60. A burst mode is initiated to transmit the buffered data via the network 52, see FIG. 2, to the gateway 54, upon detection of a crash condition. As will be apparent, the above times are by way of example only and can be adjusted as necessary or desired.

As described herein, notice of loss is reported to an insurance carrier, or the like, once an abnormal vehicular movement event is detected. Such events are pre-determined behavioural triggers that are detected through the device 50 connected to a vehicle 48. The device 50 measures vehicle movement in G-force along with acoustic readings that may indicate that a vehicular crash has occurred. Loss detection measurements and thresholds include sudden acceleration, sudden deceleration, abnormal G-force readings and acoustic amplitude.

G-force and structure borne sound wave amplitude and reporting duration thresholds are configurable parameters. Accelerometer G-force and acoustic amplitude data are compared against respective pre-set thresholds. Upon detection of a crash condition, the latest non-burst accelerometer G-force reading is saved and reported as pre-crash data. Upon detection of a crash, a crash notification is sent immediately, and data sample rates switches from non-burst to burst mode. Crash burst mode data collection and reporting takes precedence over non-burst mode. The duration of burst mode crash detection collection and transmission continues either based on a configurable set timer value or a command issued to terminate if and when necessary. Once the burst mode data reporting ends, then the device 50 reverts back to the non-burst mode.

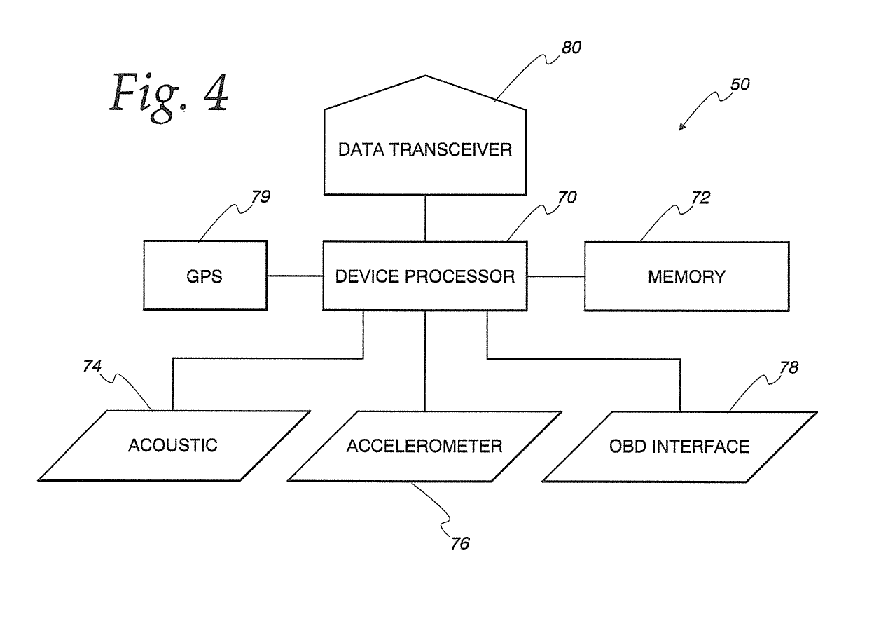

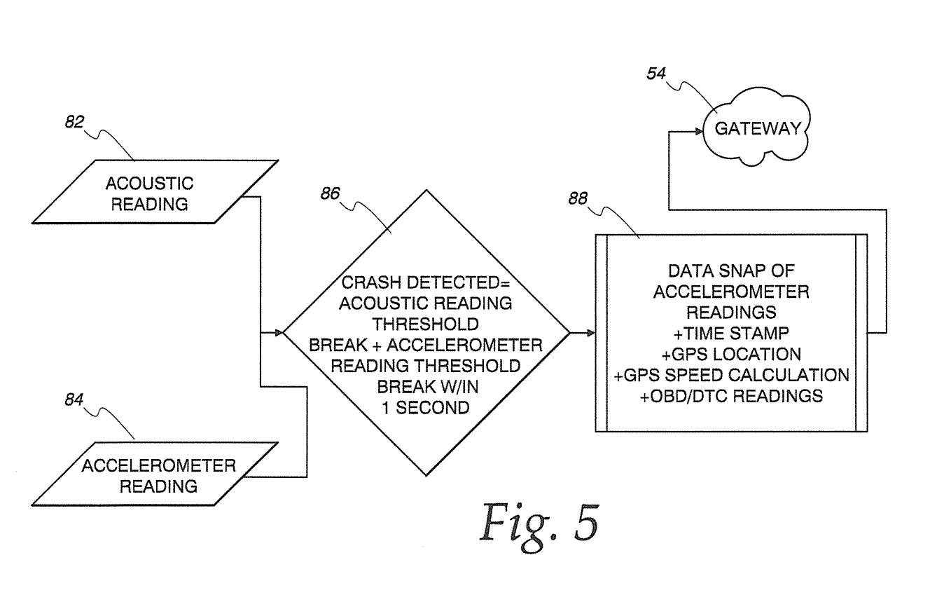

Referring to FIG. 4, the device 50 includes a device processor 70 and associated memory 72. Particularly, the processor 70 operates in accordance with a control program, as described below relative to FIG. 5, stored in the memory 72, and using data stored in the memory 72. As will be apparent, the processor 70 continually monitors vehicle operation. Such monitoring is not specifically described herein as this application is particularly directed to detection of abnormal vehicular movement events.

The processor 70 is operatively connected to an acoustic sensor 74. The acoustic sensor 74, being supported, for example, in the housing H, see FIG. 3, is fixed in the vehicle and detects structure borne sound wave amplitudes. The acoustic sensor 74 may be a MEMS chip such as an SPU0414HR5H-SB amplified microphone. The acoustic sensor reads vibrations reflected through the frame to the OBD port and thus the housing H. As such, the acoustic sensor 74 is operatively coupled in the vehicle to sense vehicular structure borne sound waves and develop an acoustic reading representative thereof.

An accelerometer 76 in the housing H is connected to the processor 70. The accelerometer senses G-force and develops an accelerometer reading representative thereof. The processor 70 is connected to an OBD interface 78 connected via the connector C, see FIG. 3, to the vehicle OBD port. This is used to read OBD data as necessary for monitoring driver behaviour and for use in loss reporting and claims adjustment. This information could include, for example, features such as air bag deployment, crash sensor activation and other circumstantial indicative variables, as necessary or desired.

As will be apparent, regardless of the structure of the device 50, the acoustic sensor 74 and the accelerometer 76 are supported in the vehicle and are responsive to vehicle movement and structure born sound waves. The support may be a separate housing, see FIG. 3, or could be an integral device manufactured in the vehicle. Thus, the housing H is just an illustrative example of a support member.

The processor 70 is also connected to a data transceiver 80. The transceiver 80 is used for communicating with the gateway 54 via the network 52. The particular form of the transceiver 80 depends upon the configuration of the network 52, as will be apparent. The processor 70 is also connected to a global positioning system block 79 to determine vehicle position in a conventional manner using signals from the transceiver 80.

Referring to FIG. 5, a flow diagram illustrates implementation of a crash detection algorithm implemented by the processor 70 in FIG. 4. The acoustic reading from the acoustic sensor 74 is obtained at a block 82. Similarly, the accelerometer reading from the accelerometer 76 is obtained at a block 84. The acoustic reading and accelerometer reading are provided to a decision block 86 which compares the acoustic reading to an acoustic amplitude threshold and the accelerometer reading to a G-force amplitude threshold. A crash condition is detected if the acoustic amplitude is greater than or equal to the acoustic amplitude threshold and the accelerometer reading is greater than or equal to the G-force amplitude threshold. If so, then data sampling is switched to a burst mode and the latest non-burst accelerometer G-force reading is saved and reported as pre-crash data. A crash notification is sent immediately at a block 88. The crash notification may include a data snapshot of accelerometer readings, a time stamp, GPS location, a GPS speed calculation and selective OBD readings. All are transferred via the network 52 to the gateway 54. Thereafter, crash data, comprising acceleration and other crash worthy information is sampled at the burst rate for a select time period or upon receipt of a termination command at which time sampling reverts to the non-burst mode.

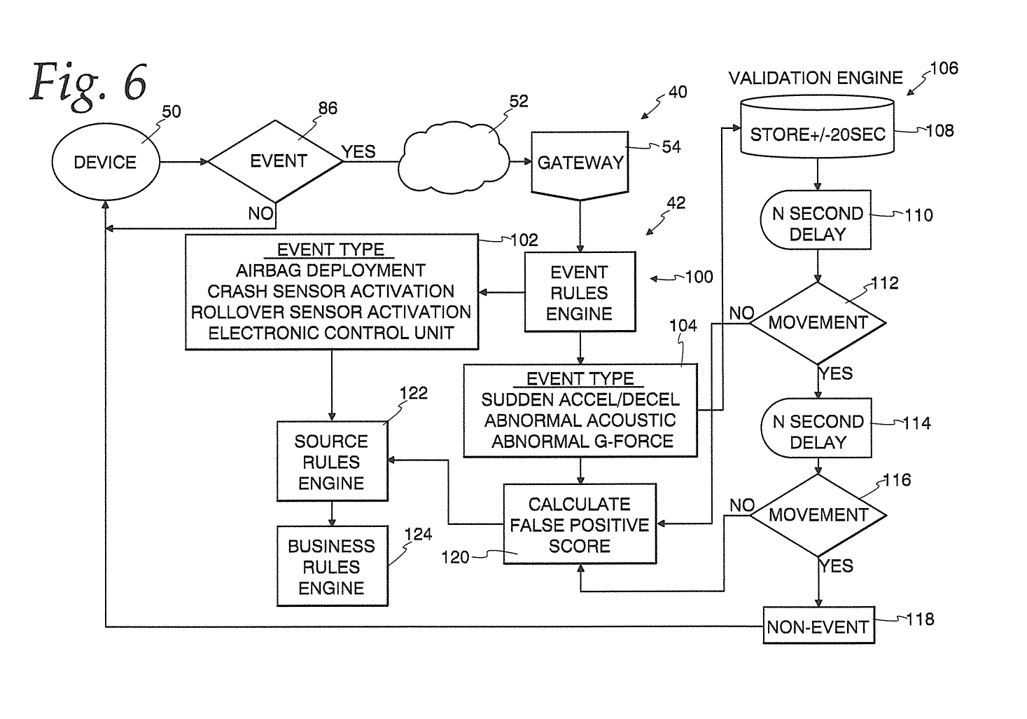

FIG. 6 comprises an overview flow chart functionally illustrating operation of the system 40. The monitoring device 50 continually generates data associated with vehicle operation, as discussed above. The decision block 86, associated with the monitoring device 50, determines if an event has been triggered, as discussed above relative to FIG. 5. If not, then the process flow returns to monitoring by the monitoring device 50. If an event has been triggered, then the monitoring device 50 transmits data associated with the abnormal vehicular movement event, see block 88, via the network 52 to the gateway 54. The data transmitted may include precise time, date and location of the event, driving behavior and vehicle status before, during and after the event, G-force impact analysis, cause of the trigger, and the number of occupants in the vehicle at the time of impact. All of these data elements can be used along with locational weather conditions, posted speed and actual speed at time of event and compared to information submitted by the policy holder, driver, third party claimant or other claim participant.

The gateway 54 provides the received data to the ICE system 42, particularly an event rules engine 100 which provides necessary information to a validation engine 106.

The event rules engine 100 initially categorizes an abnormal vehicular movement event based on severity and type of the event. If the event type is an air bag deployment, crash sensor activation, rollover sensor activation or an electronic control unit, each representing a defined event, then the event rules engine proceeds to a block 102. The event rules engine then passes the received data to a source rules engine 122 and business rules engine 124. Otherwise, if the event is categorized as sudden acceleration, sudden deceleration, abnormal acoustic signal or abnormal G-force, then the system advances to a block 104 which interfaces with the validation engine 106. The validation engine 106 begins at a node 108 which extracts the data for the time of the event and for the period subsequent to the event which may be on the order of twenty seconds. From the time of the occurrence of the event, the validation engine uses an N second delay at a block 110, which may be on the order of ten seconds. Thereafter, a decision block 112 determines if there is normal vehicular movement. If so, then another N second delay is implemented at a block 114 and then a decision block 116 determines if there is normal vehicular movement. If so, then the validation engine assumes that the event consisted of the vehicle hitting a pothole or speed bump or the like as the vehicle has resumed normal movement. The occurrence is then classified as a non-event at a block 118 and the routine ends and returns to monitoring by the monitoring device 50.

If no further vehicle movement is detected at the blocks 112 or 116, then a block 120 calculates a false positive score and this can represent the severity level of the event. The event rules engine 100 develops an output to the source rules engine 120, via the block 120, which includes the calculated validation score, post event vehicle status, raw accelerometer data, such as G-force severity, duration and rollover, OBD or GPS speed, if the accelerometer speed is not available. Vehicle identification information, such as VIN number, year, make and model, trip data and acoustic may also be transferred.

Thus, as described herein, an automated crash detection device comprises a housing mountable in a vehicle. An acoustic sensor is operatively coupled to the housing to sense vehicle structure born sound waves and develop an acoustic reading representative thereof. An accelerometer is operatively coupled to the housing to sense G-force and develop an accelerometer reading representative thereof. A processing system is operatively associated with the acoustic sensor and the accelerometer to detect a crash condition responsive to the acoustic reading and the accelerometer reading. A transmitter is operatively associated with the processing system to transmit a crash notification upon detection of a crash condition.

It will be appreciated by those skilled in the art that there are many possible modifications to be made to the specific forms of the features and components of the disclosed embodiments while keeping within the spirit of the concepts disclosed herein. Accordingly, no limitations to the specific forms of the embodiments disclosed herein should be read into the claims unless expressly recited in the claims. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A device for detecting abnormal vehicular movement events, comprising:
a support member mountable in a vehicle;
an acoustic sensor operatively coupled to the support member to sense vehicle structure born sound waves and develop an acoustic reading representative thereof;
an accelerometer operatively coupled to the support member to sense g-force and develop an accelerometer reading representative thereof; and
a processing circuit operatively associated with the acoustic sensor and the accelerometer to detect a crash condition responsive to the acoustic reading and the accelerometer reading.

2. The device of claim 1 wherein the processing circuit detects a crash condition responsive to both the acoustic reading and the accelerometer reading being above a select threshold.

3. The device of claim 1 further comprising a transmitter operatively associated with the processing circuit to transmit a crash notification upon detection of a crash condition.

4. The device of claim 3 wherein the processing circuit stores a previous accelerometer reading as pre-crash data upon detection of a crash condition.

5. The device of claim 1 wherein the processing circuit comprises a global positioning system to track vehicle location.

6. The device of claim 3 wherein the processing circuit comprises a global positioning system and the processing circuit transmits vehicle location with the crash notification upon detection of a crash condition.

7. The device of claim 1 further comprising an interface coupled to a vehicle on board diagnostic (OBD) device, in use, and the processing circuit stores OBD data.

8. The device of claim 7 further comprising a transmitter operatively associated with the processing circuit to transmit a crash notification upon detection of a crash condition, the crash notification comprising OBD data.

9. The device of claim 8 wherein the processing circuit samples OBD data and acoustic readings and accelerometer readings in a non-burst mode in the absence of a crash condition and upon detection of a crash condition data sample rate switches to a burst mode.

10. The device of claim 9 wherein duration of burst mode data collection and transmission continues for a select period subsequent to detection of a crash condition.

11. An automated crash detection device, comprising:
a housing mountable in a vehicle;
an acoustic sensor operatively coupled to the housing to sense vehicle structure born sound waves and develop an acoustic reading representative thereof;
an accelerometer operatively coupled to the housing to sense g-force and develop an accelerometer reading representative thereof;
a processing system operatively associated with the acoustic sensor and the accelerometer to detect a crash condition responsive to the acoustic reading and the accelerometer reading; and
a transmitter operatively associated with the processing system to transmit a crash notification upon detection of a crash condition.

12. The device of claim 11 wherein the processing system detects a crash condition responsive to both the acoustic reading and the accelerometer reading being above a select threshold.

13. The device of claim 11 wherein the transmitter comprises a wireless transmitter.

14. The device of claim 11 wherein the processing system stores a previous accelerometer reading as pre-crash data upon detection of a crash condition.

15. The device of claim 11 wherein the processing system comprises a global positioning system to track vehicle location.

16. The device of claim 11 wherein the processing system comprises a global positioning system and the processing system transmits vehicle location with the crash notification upon detection of a crash condition.

17. The device of claim 11 further comprising an interface coupled to a vehicle on board diagnostic (OBD) device, in use, and the processing system stores OBD data.

18. The device of claim 17 wherein the crash notification comprises OBD data.

19. The device of claim 18 wherein the processing system samples OBD data and acoustic readings and accelerometer readings in a non-burst mode in the absence of a crash condition and upon detection of a crash condition data sample rate switches to a burst mode.

20. The device of claim 19 wherein duration of burst mode data collection and transmission continues for a select period subsequent to detection of a crash condition.
